(19) United States
(12) Patent Application Publication
(10) Pub. No.: US 2022/0177808 A1
(43) Pub. Date: Jun. 9, 2022

(54) CATIONIC SURFACTANT AND ITS USE IN LAUNDRY DETERGENT COMPOSITIONS

(71) Applicant: BASF SE, Ludwigshafen am Rhein (DE)

(72) Inventors: Susanne Carina Engert, Ludwigshafen (DE); Matthias Kellermeier, Ludwigshafen (DE); Katrin-Stephanie Tuecking, Ludwigshafen (DE); Hans-Christian Raths, Düsseldorf-Holthausen (DE); Guenter Oetter, Ludwigshafen (DE); Nadine Engelhardt, Ludwigshafen (DE); Alejandra Garcia Marcos, Ludwigshafen (DE); Lydia Braun, Ehekirchen (DE)

(21) Appl. No.: 17/436,992

(22) PCT Filed: Mar. 2, 2020
(86) PCT No.: PCT/EP2020/055445

§ 371 Date: Sep. 7, 2021

(30) Foreign Application Priority Data
Mar. 8, 2019 (EP) 19161669.7

(51) Int. Cl. C11D 1/65; C11D 11/00; C11D 3/386

(52) U.S. Cl. CPC C11D 1/65; C11D 1/62; C11D 3/38627; C11D 11/0017

(57) ABSTRACT

Described herein is a cationic surfactant. Also described herein is a method of using the cationic surfactant, the method including using the cationic surfactant in laundry detergent compositions (for example in combination with an anionic surfactant, nonionic surfactant and/or enzyme).

The present invention relates to a new cationic surfactant and its use in laundry detergent compositions (for example in combination with an anionic surfactant, nonionic surfactant and/or enzyme).

Laundry detergent compositions containing cationic and anionic surfactants in combination are disclosed in WO2013/070824A1, WO1998013451, WO9712018A (Procter & Gamble), WO01/59048 (Unilever PLC).

However, most of the laundry detergent compositions still show room for improvement, in particular regarding their washing performance. In addition, most laundry detergent compositions contain enzymes, and enzyme stability in the laundry detergent compositions is always an issue.

Thus, there was a need in the art for ingredients of laundry detergent compositions, in particular surfactants, which contribute to an improved washing performance. Furthermore, there was a need in the art for ingredients of laundry detergent compositions, in particular surfactants, which contribute to an improved enzyme stability.

Surprisingly it has now been found that the use of certain cationic surfactants, preferably in combination with certain anionic and/or nonionic surfactants and/or enzymes, in a laundry detergent composition (preferably a liquid laundry detergent composition), lead to an improved washing performance (in particular on fatty stains). Furthermore, the use of certain cationic surfactants, preferably in combination with certain anionic and/or nonionic surfactants, in a laundry detergent composition (preferably a liquid laundry detergent composition), leads to an improved stability of the enzymes contained in the composition. In addition, it has surprisingly been found that combining the inventive cationic surfactants with certain enzymes (in particular lipases) leads to a synergistic increase of the washing performance of the respective laundry detergent compositions.

Washing or cleaning performance is evaluated under relevant washing conditions. The term “relevant washing conditions” herein refers to the conditions, particularly washing temperature, time, washing mechanics, suds concentration, type of laundering formulation and water hardness, actually used in laundry machines, or in manual washing processes.

Fatty stains usually comprise at least one industrial fat which can be sub-classified as fat, grease or oil depending on the melting temperature. Oil is usually liquid at room temperature. Grease has a higher viscosity than oil at room temperature and be called pasty. The removal of oily and greasy stains deposited on textiles, due to the relatively low melting temperature of oil and grease, is supported by laundering temperatures ≥30° C. The removal of fatty stains deposited on textiles having a melting temperature >30° C., meaning which remain solid at temperatures ≤30° C., is a particular problem in laundry formulation. Washing or cleaning performance on fatty stains may be called degreasing performance herein.

Laundering at temperatures ≤30° C. may be desired for laundering heat-sensitive textiles, when doing the laundry by hand, or due to considerations of saving energy which demands avoiding heating of water. Consequently, there is a need to provide laundry compositions effective in removing fatty stains having a melting temperature >30° C. deposited on textiles at laundering temperatures ≤30° C.

Thus, one object of the present invention is a cationic surfactant of the formula X⁻

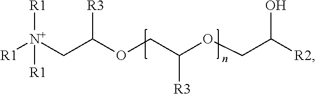

wherein X represents an anionic counterion, n is from 0 to 20, R1 independently from each other represent a linear, branched or cyclic alkyl or benzyl moiety or propan-2-ol moiety, R2 represents a linear, branched or cyclic alkyl or aryl moiety, preferably selected from alkyl moieties with 2 to 18 C, and R 3 independently from each other represent, preferably, hydrogen, or alternatively a linear, branched or cyclic alkyl moiety.

In a preferred embodiment of the inventive cationic surfactant, X is selected from the list consisting of —OSO3Me⁻ and —Cl⁻, n=1, R1 represents —CH3, R2 is a linear alkyl moiety with 10 C atoms and R3 is hydrogen.

An object of the present invention is also a laundry detergent composition, comprising at least one inventive cationic surfactant as defined above and at least one compound selected from the list consisting of anionic surfactants, nonionic surfactants and enzymes.

Further objects of the present invention are also the use of an inventive cationic surfactant in a laundry detergent composition, in particular the use of an inventive cationic surfactant for increasing enzyme stability in a laundry detergent composition comprising at least one enzyme, and a process for removing fatty stains on a textile fabric by using a laundry detergent composition comprising an inventive cationic surfactant.

The invention provides the use of an inventive cationic surfactant to improve the washing or cleaning performance of laundry detergent compositions by at least 2%, at least 3%, at least 4%, at least 5%, at least 6%, or at least 7% when compared to laundry detergent composition not comprising the inventive cationic surfactant. In one embodiment, the washing or cleaning performance is increased in laundry detergent compositions comprising an inventive cationic surfactant and an enzyme, preferably a lipase. The washing or cleaning performance of laundry detergent compositions comprising an inventive cationic surfactant and a lipase may be increased by at least 10% when compared to laundry detergent compositions comprising the same lipase but not comprising the inventive cationic surfactant. Preferably, the washing or cleaning performance is increased at laundering temperatures ≤30° C.

The invention provides the use of an inventive cationic surfactant to improve the degreasing performance of laundry detergent compositions by at least 5%, at least 7%, at least 10%, at least 5%, at least 6%, at least 7% when compared to laundry detergent composition not comprising the inventive cationic surfactant. In one embodiment, the degreasing performance is increased in laundry detergent compositions comprising an inventive cationic surfactant and an enzyme, preferably a lipase. The degreasing performance of laundry detergent compositions comprising an inventive cationic surfactant and a lipase may be increased by at least 10%, or at least 15% when compared to laundry detergent compositions comprising the same lipase but not comprising the inventive cationic surfactant. Preferably, the degreasing performance is increased at laundering temperatures ≤30° C. In one embodiment, the degreasing performance towards fatty deposits with a melting temperature >30° C. may be increased such as beef fat. In an embodiment of the inventive cationic surfactant, X is selected from the list consisting of —OSO3Me⁻, —Cr, —I⁻ and —Br⁻, preferably —OSO3Me⁻ or —Cl⁻.

In a further embodiment of the inventive cationic surfactant, n is from 0 to 5, preferably 1 to 5, even more preferably 1.

In a further embodiment of the inventive cationic surfactant, n is from 1 to 20, preferably 1 to 5, even more preferably 1.

In a further embodiment of the inventive cationic surfactant, R1 are independently from each other selected from the list consisting of —CH3, —C2H5, —C3H7, preferably —CH3.

In a further embodiment of the inventive cationic surfactant, R2 is selected from linear, branched or cyclic alkyl moieties with 2 to 18 C, preferably 4 to 18 C atoms.

In a further embodiment of the inventive cationic surfactant, R2 is selected from the list consisting of alkyl moieties with 4, 6, 8, 10, 12 C atoms, preferably 10 C atoms.

In a further embodiment of the inventive cationic surfactant, R3 are independently from each other selected from the list consisting of —H, —CH3, —C2H5, preferably —H or —CH3, more preferably hydrogen.

In an embodiment of the laundry detergent composition, the laundry detergent composition is a liquid laundry detergent composition. “Liquid” refers to the physical appearance at 20° C. and 101.3 kPa.

In a further embodiment of the laundry detergent composition, comprising at least one inventive cationic surfactant as defined above and at least one anionic surfactant.

In a further embodiment of the laundry detergent composition, the anionic surfactant is a sulfate or sulfonate or combinations thereof.

In a further embodiment of the laundry detergent composition, the anionic surfactant is selected from the list consisting of alkylether sulfates and alkylbenzene sulfonates or combinations thereof, preferably alkyl benzene sulfonate.

In a preferred embodiment, the inventive laundry detergent composition does not contain laurylether sulfate.

In a further embodiment of the laundry detergent composition, the ratio between the cationic surfactant and the anionic surfactant is in the range of 1:1 to 1:10, preferably 1:2 to 1:6, more preferably 1.0:5.1 (wt/wt).

In a further embodiment of the laundry detergent composition, the composition comprises at least one cationic surfactant as defined above and at least one nonionic surfactant.

In a further embodiment of the laundry detergent composition, the ratio between the cationic surfactant and the nonionic surfactant is in the range of 1:0-1:10, preferably 1:5 (wt/wt).

In a further preferred embodiment, the inventive laundry detergent composition comprises at least one enzyme.

Preferably, the enzyme is selected from the list consisting of proteases, amylases, mannanases, lipases and cellulases, preferably lipase.

In a preferred embodiment of the invention, the laundry detergent composition contains an amount of lipase in the range of 0.0002%-0.02% by weight active, preferably 0.001-0.006% by weight active, relative to the total weight of the composition.

In a particularly preferred embodiment, the inventive laundry detergent composition comprises a so-called laundry lipase, preferably selected from serine hydrolases.

“Lipases”, “lipolytic enzyme”, “lipid esterase”, all refer to enzymes of EC class 3.1.1 (“carboxylic ester hydrolase”). Such a lipase may have lipase activity (or lipolytic activity; triacylglycerol lipase, EC 3.1.1.3), cutinase activity (EC 3.1.1.74; enzymes having cutinase activity may be called cutinase herein), sterol esterase activity (EC 3.1.1.13) and/or wax-ester hydrolase activity (EC 3.1.1.50). Commercially available lipase include but are not limited to those sold under the trade names Lipolase™ Lipex™ Lipolex™ and Lipoclean™ (Novozymes A/S), Lumafast (originally from Genencor) and Lipomax (Gist-Brocades/now DSM).

In one aspect of the invention, a suitable lipase is selected from the following:
lipases from Humicola (synonym Thermomyces), e.g. from H. lanuginosa (T. lanuginosus) as described in EP 258068, EP 305216, WO 92/05249 and WO 2009/109500 or from H. insolens as described in WO 96/13580,
lipases derived from Rhizomucor miehei as described in WO 92/05249.
lipase from strains of Pseudomonas (some of these now renamed to Burkholderia), e.g. from P. alcaligenes or P. pseudoalcaligenes (EP 218272, WO 94/25578, WO 95/30744, WO 95/35381, WO 96/00292), P. cepacia (EP 331376), P. stutzeri (GB 1372034), P. fluorescens, Pseudomonas sp. strain SD705 (WO 95/06720 and WO 96/27002), P. wiscon-sinensis (WO 96/12012), Pseudomonas mendocina (WO 95/14783), P. glumae (WO 95/35381, WO 96/00292)
lipase from Streptomyces griseus (WO 2011/150157) and S. pristinaespiralis (WO 2012/137147), GDSL-type Streptomyces lipases (WO 2010/065455),
lipase from Thermobifida fusca as disclosed in WO 2011/084412,
lipase from Geobacillus stearothermophilus as disclosed in WO 2011/084417,
Bacillus lipases, e.g. as disclosed in WO 00/60063, lipases from B. subtilis as disclosed in Dartois et al. (1992), Biochemica et Biophysica Acta, 1131, 253-360 or WO 2011/084599, B. stearothermophilus (JP S64-074992) or B. pumilus (WO 91/16422).
Lipase from Candida antarctica as disclosed in WO 94/01541.
cutinase from Pseudomonas mendocina (U.S. Pat. No. 5,389,536, WO 88/09367)
cutinase from Magnaporthe grisea (WO 2010/107560),
cutinase from Fusarum solani pisi as disclosed in WO 90/09446, WO 00/34450 and WO 01/92502
cutinase from Humicola lanuginosa as disclosed in WO 00/34450 and WO 01/92502

Suitable lipases also include those referred to as acyltransferases or perhydrolases, e.g. acyltransferases with homology to Candida antarctica lipase A (WO 2010/111143), acyltransferase from Mycobacterium smegmatis (WO 2005/056782), perhydrolases from the CE7 family (WO 2009/67279), and variants of the M. smegmatis perhydrolase in particular the S54V variant (WO 2010/100028).

Lipases include those of bacterial or fungal origin. Suitable lipases include also those which are variants of the above described lipases and/or cutinases which have lipolytic activity. Such suitable lipase variants are e.g. those which are developed by methods as disclosed in WO 95/22615, WO 97/04079, WO 97/07202, WO 00/60063, WO 2007/087508, EP 407225 and EP 260105.

In one embodiment, lipase is a fungal triacylglycerol lipase from Thermomyces lanuginosa such as triacylglycerol lipase according to amino acids 1-269 of SEQ ID NO: 2 of U.S. Pat. No. 5,869,438 (may be called Lipolase herein) and variants thereof having lipolytic activity.

Variants of Thermomyces lanuginosa lipase according to amino acids 1-269 of SEQ ID NO: 2 of U.S. Pat. No. 5,869,438 may be selected from variants having lipolytic activity which are at least 90%, at least 91%, at least 92%, at least 93%, at least 94%, at least 95%, at least 96%, at least 97%, at least 98% or at least 99% identical or similar when compared to the full length polypeptide sequence of amino acids 1-269 of SEQ ID NO: 2 of U.S. Pat. No. 5,869,438. The variants may be selected from polypeptide sequences being at least 90%, at least 91%, at least 92%, at least 93%, at least 94%, at least 95%, at least 96%, at least 97%, at least 98% or at least 99% identical or similar when compared to the full length polypeptide sequence of amino acids 1-269 of SEQ ID NO: 2 of U.S. Pat. No. 5,869,438.

Thermomyces lanuginosa lipase may be selected from variants selected from polypeptide sequences being at least 90%, at least 91%, at least 92%, at least 93%, at least 94%, at least 95%, at least 96%, at least 97%, at least 98% or at least 99% identical or similar when compared to the full length polypeptide sequence of amino acids 1-269 of SEQ ID NO: 2 of U.S. Pat. No. 5,869,438 having lipolytic activity comprising at least the following amino acid substitutions when compared to amino acids 1-269 of SEQ ID NO: 2 of U.S. Pat. No. 5,869,438: T231R and N233R (enzyme having amino acids 1-269 of SEQ ID NO: 2 of U.S. Pat. No. 5,869,438 T231R and N233R may be called Lipex herein). Said lipase variants may further comprise one or more of the following amino acid exchanges when compared to amino acids 1-269 of SEQ ID NO: 2 of U.S. Pat. No. 5,869,438: Q4V, V60S, A150G, L227G, P256K.

Suitable lipases include also those that are variants of the above described lipases/cutinases which have lipolytic activity. Suitable lipase/cutinase variants include variants with at least 40 to 100% identity when compared to the full length polypeptide sequence of the parent enzyme as disclosed above. In one embodiment lipase/cutinase variants having lipolytic activity may be at least 40%, at least 45%, at least 50%, at least 55%, at least 60%, at least 65%, at least 70%, at least 75%, at least 80%, at least 85%, at least 90%, at least 91%, at least 92%, at least 93%, at least 94%, at least 95%, at least 96%, at least 97%, at least 98% or at least 99% identical when compared to the full length polypeptide sequence of the parent enzyme as disclosed above.

For calculation of sequence identities, in a first step a sequence alignment has to be produced. According to this invention, a pairwise global alignment has to be produced, meaning that two sequences have to be aligned over their complete length, which is usually produced by using a mathematical approach, called alignment algorithm.

According to the invention, the alignment is generated by using the algorithm of Needleman and Wunsch (J. Mol. Biol. (1979) 48, p. 443-453). Preferably, the program “NEEDLE” (The European Molecular Biology Open Software Suite (EMBOSS)) is used for the purposes of the current invention, with using the programs default parameter (polypeptides: gap open=10.0, gap extend=0.5 and matrix=EBLOSUM62).

After aligning two sequences, in a second step, an identity value is determined from the alignment produced.

In one embodiment, the %-identity is calculated by dividing the number of identical residues by the length of the alignment region which is showing the respective sequence of this invention over its complete length multiplied with 100: %-identity=(identical residues/length of the alignment region which is showing the respective sequence of this invention over its complete length)*100.

In a preferred embodiment, the %-identity is calculated by dividing the number of identical residues by the length of the alignment region which is showing the two aligned sequences over their complete length multiplied with 100: %-identity=(identical residues/length of the alignment region which is showing the two aligned sequences over their complete length)*100.

In another embodiment, inventive compositions comprise at least one lipase/cutinase variant comprising conservative mutations not pertaining the functional domain of the respective lipase/cutinase. Lipase/cutinase variants of such embodiments having lipolytic activity may be at least 40%, at least 45%, at least 50%, at least 55%, at least 60%, at least 65%, at least 70%, at least 75%, at least 80%, at least 85%, at least 90%, at least 91%, at least 92%, at least 93%, at least 94%, at least 95%, at least 96%, at least 97%, at least 98% or at least 99% similar when compared to the full length polypeptide sequence of the parent enzyme.

Sequence similarity takes into account that defined sets of amino acids share similar properties, e.g. by their size, by their hydrophobicity, by their charge, or by other characteristics. Herein, the exchange of one amino acid with a similar amino acid may be called “conservative mutation”. Similar amino acids according to the invention are defined as follows: amino acid A is similar to amino acids S; amino acid D is similar to amino acids E and N; amino acid E is similar to amino acids D, K, and Q; amino acid F is similar to amino acids W and Y; amino acid H is similar to amino acids N and Y; amino acid I is similar to amino acids L, M, and V; amino acid K is similar to amino acids E, Q, and R; amino acid L is similar to amino acids I, M, and V; amino acid M is similar to amino acids I, L, and V; amino acid N is similar to amino acids D, H, and S; amino acid Q is similar to amino acids E, K, and R; amino acid R is similar to amino acids K and Q; amino acid S is similar to amino acids A, N, and T; amino acid T is similar to amino acids S; amino acid V is similar to amino acids I, L, and M; amino acid W is similar to amino acids F and Y; amino acid Y is similar to amino acids F, H, and W.

Conservative amino acid substitutions may occur over the full length of the sequence of a polypeptide sequence of a functional protein such as an enzyme. In one embodiment, such mutations are not pertaining the functional domains of an enzyme. In one embodiment, conservative mutations are not pertaining the catalytic centers of an enzyme.

For calculation of sequence similarity is, in a first step a sequence alignment has to be produced as described above.

In one embodiment, the %-similarity is calculated by dividing the number of identical residues plus the number of similar residues by the length of the alignment region which is showing the respective sequence of this invention over its complete length multiplied with 100: %-similarity=[(identical residues+similar residues)/length of the alignment region which is showing the respective sequence of this invention over its complete length]*100.

In a preferred embodiment, the %-similarity is calculated by dividing the number of identical residues plus the number of similar residues by the length of the alignment region which is showing the two aligned sequences over their complete length multiplied with 100: %-similarity=[(identical residues+similar residues)/length of the alignment region which is showing the two aligned sequences over their complete length]*100.

Lipases have “lipolytic activity”. The methods for determining lipolytic activity are well-known in the literature (see e.g. Gupta et al. (2003), Biotechnol. Appl. Biochem. 37, p. 63-71). E.g. the lipase activity may be measured by ester bond hydrolysis in the substrate para-nitrophenyl palmitate (pNP-Palmitate, C:16) and releases pNP which is yellow and can be detected at 405 nm.

Lipase variants may have lipolytic activity according to the present invention when said lipase variants exhibit at least 20%, at least 25%, at least 30%, at least 35%, at least 40%, at least 45%, at 10 least 50%, at least 55%, at least 60%, at least 65%, at least 70%, at least 75%, at least 80%, at least 85%, at least 90%, at least 95%, or 100% of the lipolytic activity of the respective parent lipase.

In one embodiment of the present invention, a combination of at least two of the foregoing lipases may be used.

Lipase may be used in its non-purified form or in a purified form, e.g. purified with the aid of well-known adsorption methods, such as phenyl sepharose adsorption techniques.

In one embodiment of the present invention, lipases are included in inventive composition in such an amount that a finished inventive composition has a lipolytic enzyme activity in the range of from 100 to 0.005 LU/mg, preferably 25 to 0.05 LU/mg of the composition. A Lipase Unit (LU) is that amount of lipase which produces 1 μmol of titratable fatty acid per minute in a pH stat. under the following conditions: temperature 30° C.; pH=9.0; substrate is an emulsion of 3.3 wt. % of olive oil and 3.3% gum arabic, in the presence of 13 mmol/l Ca²⁺ and 20 mmol/1 NaCl in 5 mmol/l Tris-buffer.

In a preferred embodiment of the invention, the laundry detergent composition contains an amount of lipase in the range of 0.0002%-0.02% by weight active, preferably 0.001-0.006% by weight active, relative to the total weight of the composition.

Enzymatic activity may change during storage or operational use of the enzyme. The term “enzyme stability” relates to the retention of enzymatic activity as a function of time during storage or operation. The term “storage” herein means to indicate the fact of products or compositions or formulations being stored from the time of being manufactured to the point in time of being used in final application. Retention of enzymatic activity as a function of time during storage in detergent may be called “storage stability” herein.

In the context of the present invention, lipase is deemed called stable when its enzymatic activity “available in application” equals 100% when compared to the initial enzymatic activity before storage. An enzyme may be called stable within this invention if its enzymatic activity available in application is at least 60%, at least 65%, at least 70%, at least 75%, at least 80%, at least 85%, at least 90%, at least 91%, at least 92%, at least 93%, at least 94%, at least 95%, at least 96%, at least 97%, at least 98%, at least 99%, or at least 99.5% when compared to the initial enzymatic activity before storage.

In one embodiment, lipolytic activity available after storage at 37° C. for 30 days is at least 60% when compared to the initial lipolytic activity before storage. In one embodiment, after 28 d of storage at 37° C. lipase has increased residual enzyme activity in a detergent formulation comprising cationic surfactant when compared to a detergent formulation lacking said cationic surfactant.

Subtracting a % from 100% gives the “loss of enzymatic activity during storage” when compared to the initial enzymatic activity before storage. In one embodiment, an enzyme is stable according to the invention when essentially no loss of enzymatic activity occurs during storage, i.e. loss in enzymatic activity equals 0% when compared to the initial enzymatic activity before storage. Essentially no loss of enzymatic activity within this invention may mean that the loss of enzymatic activity is less than 30%, less than 25%, less than 20%, less than 15%, less than 10%, less than 9%, less than 8%, less than 7%, less than 6%, less than 5%, less than 2%, or less than 1%.

The laundry detergent compositions of the present invention may contain additional ingredients common in the art.

Inventive compositions may comprise ingredients other than the aforementioned. Examples are non-ionic surfactants, fragrances, dyestuffs, biocides, preservatives, enzymes, hydrotropes, builders, viscosity modifiers, polymers, buffers, defoamers, and anti-corrosion additives.

Preferred inventive compositions may contain one or more non-ionic surfactants.

Preferred non-ionic surfactants are alkoxylated alcohols, di- and multiblock copolymers of ethylene oxide and propylene oxide and reaction products of sorbitan with ethylene oxide or propylene oxide, alkyl polyglycosides (APG), hydroxyalkyl mixed ethers and amine oxides.

Preferred examples of alkoxylated alcohols and alkoxylated fatty alcohols are, for example, compounds of the general formula (II)

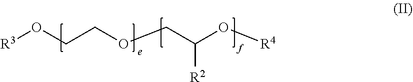

in which the variables are defined as follows:
R² is identical or different and selected from hydrogen and linear C₁-C₁₀-alkyl, preferably in each case identical and ethyl and particularly preferably hydrogen or methyl,
R³ is selected from C₈-C₂₂-alkyl, branched or linear, for example n-C₈H₁₇, n-C₁₀H₂₁, n-C₁₂H₂₅, n-C₁₄H₂₉, n-C₁₆H₃₃ or n-C₁₈H₃₇,
R⁴ is selected from C₁-C₁₀-alkyl, methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, 2-ethylhexyl, n-nonyl, n-decyl or isodecyl,
   m and n are in the range from zero to 300, where the sum of n and m is at least one, preferably in the range of from 3 to 50. Preferably, m is in the range from 1 to 100 and n is in the range from 0 to 30.

In one embodiment, compounds of the general formula (II) may be block copolymers or random copolymers, preference being given to block copolymers.

Other preferred examples of alkoxylated alcohols are, for example, compounds of the general formula (III)

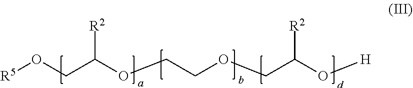

in which the variables are defined as follows:
R² is identical or different and selected from hydrogen and linear C₁-C₀-alkyl, preferably identical in each case and ethyl and particularly preferably hydrogen or methyl,
R⁵ is selected from C₆-C₂₀-alkyl, branched or linear, in particular n-C₈H₁₇, n-C₁₀H₂₁, n-C₁₂H₂₅, n-C₁₃H₂₇, n-C₁₅H₃₁, n-C₁₄H₂₉, n-C₁₆H₃₃, n-C₁₈H₃₇,
a is a number in the range from zero to 10, preferably from 1 to 6,
b is a number in the range from 1 to 80, preferably from 4 to 20,
d is a number in the range from zero to 50, preferably 4 to 25.

The sum a+b+d is preferably in the range of from 5 to 100, even more preferably in the range of from 9 to 50.

Compounds of the general formula (III) may be block copolymers or random copolymers, preference being given to block copolymers.

Further suitable nonionic surfactants are selected from di- and multiblock copolymers, composed of ethylene oxide and propylene oxide. Further suitable nonionic surfactants are selected from ethoxylated or propoxylated sorbitan esters. Amine oxides or alkyl polyglycosides, especially linear C₄-C₁₆-alkyl polyglucosides and branched C₈-C₁₄-alkyl polyglycosides such as compounds of general average formula (VI) are likewise suitable.

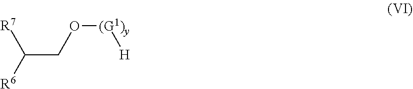

wherein:
R⁶ is C₁-C₄-alkyl, in particular ethyl, n-propyl or isopropyl,
R⁷ is —(CH₂)₂—R⁶,
G¹ is selected from monosaccharides with 4 to 6 carbon atoms, especially from glucose and xylose,
y in the range of from 1.1 to 4, y being an average number,

Further examples of non-ionic surfactants are compounds of general formula (VII) and (VIII)

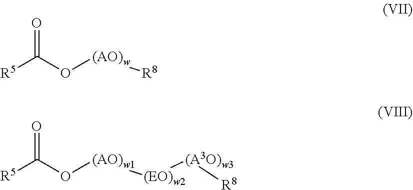

AO is selected from ethylene oxide, propylene oxide and butylene oxide,
EO is ethylene oxide, CH₂CH₂—O,
R⁸ selected from C₈-C₁₈-alkyl, branched or linear, and R⁵ is defined as above.
A³O is selected from propylene oxide and butylene oxide,
w is a number in the range of from 15 to 70, preferably 30 to 50,
w1 and w3 are numbers in the range of from 1 to 5, and
w2 is a number in the range of from 13 to 35.

An overview of suitable further nonionic surfactants can be found in EP-A 0 851 023 and in DE-A 198 19 187.

Mixtures of two or more different nonionic surfactants selected from the foregoing may also be present.

Other surfactants that may be present are selected from amphoteric (zwitterionic) surfactants and anionic surfactants and mixtures thereof.

Examples of amphoteric surfactants are those that bear a positive and a negative charge in the same molecule under use conditions. Preferred examples of amphoteric surfactants are so-called betaine-surfactants. Many examples of betaine-surfactants bear one quaternized nitrogen atom and one carboxylic acid group per molecule. A particularly preferred example of amphoteric surfactants is cocamidopropyl betaine (lauramidopropyl betaine).

Examples of amine oxide surfactants are compounds of the general formula (IX)

R⁹R¹⁰R¹¹N→O (IX)

wherein R⁹, R¹⁰, and R¹¹ are selected independently from each other from aliphatic, cycloaliphatic or C₂-C₄-alkylene C₁₀-C₂₀-alkylamido moieties. Preferably, R⁹ is selected from C₈-C₂₀-alkyl or C₂-C₄-alkylene C₁₀-C₂₀-alkylamido and R¹⁹ and R¹¹ are both methyl.

A preferred example is lauryl dimethyl aminoxide, sometimes also called lauramine oxide. A further particularly preferred example is cocamidylpropyl dimethylaminoxide, sometimes also called cocamidopropylamine oxide.

In one embodiment of the present invention, inventive compositions may contain 0.1 to 60% by weight of at least one surfactant, selected from non-ionic surfactants, amphoteric surfactants and amine oxide surfactants.

In a preferred embodiment, inventive laundry detergent compositions do not contain any anionic surfactant.

Inventive compositions may contain at least one bleaching agent, also referred to as bleach. Bleaching agents may be selected from chlorine bleach and peroxide bleach, and peroxide bleach may be selected from inorganic peroxide bleach and organic peroxide bleach. Preferred are inorganic peroxide bleaches, selected from alkali metal percarbonate, alkali metal perborate and alkali metal persulfate.

Examples of organic peroxide bleaches are organic percarboxylic acids, especially organic percarboxylic acids.

In inventive compositions, alkali metal percarbonates, especially sodium percarbonates, are preferably used in coated form. Such coatings may be of organic or inorganic nature. Examples are glycerol, sodium sulfate, silicate, sodium carbonate, and combinations of at least two of the foregoing, for example combinations of sodium carbonate and sodium sulfate.

Suitable chlorine-containing bleaches are, for example, 1,3-dichloro-5,5-dimethylhydantoin, N-chlorosulfamide, chloramine T, chloramine B, sodium hypochlorite, calcium hypochlorite, magnesium hypochlorite, potassium hypochlorite, potassium dichloroisocyanurate and sodium dichloroisocyanurate.

Inventive compositions may comprise, for example, in the range from 3 to 10% by weight of chlorine-containing bleach.

Inventive compositions may comprise one or more bleach catalysts. Bleach catalysts can be selected from bleach-boosting transition metal salts or transition metal complexes such as, for example, manganese-, iron-, cobalt-, ruthenium- or molybdenum-selenium complexes or carbonyl complexes. Manganese, iron, cobalt, ruthenium, molybdenum, titanium, vanadium and copper complexes with nitrogen-containing tripod ligands and also cobalt-, iron-, copper- and ruthenium-amine complexes can also be used as bleach catalysts.

Inventive compositions may comprise one or more bleach activators, for example N-methylmorpholinium-acetonitrile salts (“MMA salts”), trimethylammonium acetonitrile salts, N-acylimides such as, for example, N-nonanoylsuccinimide, 1,5-diacetyl-2,2-dioxohexahydro-1,3,5-triazine (“DADHT”) or nitrile quats (trimethylammonium acetonitrile salts).

Further examples of suitable bleach activators are tetraacetylethylenediamine (TAED) and tetraacetylhexylenediamine.

In one embodiment, a liquid composition comprising at least one enzyme according to the invention does not contain bleach.

Examples of fragrances are benzyl salicylate, 2-(4-tert.-butylphenyl) 2-methylpropional, commercially available as Lilial®, and hexyl cinnamaldehyde.

Examples of dyestuffs are Acid Blue 9, Acid Yellow 3, Acid Yellow 23, Acid Yellow 73, Pigment Yellow 101, Acid Green 1, Solvent Green 7, and Acid Green 25.

Inventive compositions may contain one or more preservatives or biocides. Biocides and preservatives prevent alterations of inventive liquid detergent compositions due to attacks from microorganisms. Examples of biocides and preservatives are BTA (1,2,3-benzotriazole), benzalkonium chlorides, 1,2-benzisothiazolin-3-one (“BIT”), 2-methyl-2H-isothiazol-3-one (MIT″) and 5-chloro-2-methyl-2H-isothiazol-3-one (CIT″), benzoic acid, sorbic acid, iodopropynyl butylcarbamate (“IPBC”), dichlorodimethylhydantoine (“DCDMH”), bromochlorodimethylhydantoine (“BCDMH”), and dibromodimethylhydantoine (“DBDMH”).

Examples of viscosity modifiers are agar-agar, carragene, tragacanth, gum arabic, alginates, pectins, hydroxyethyl cellulose, hydroxypropyl cellulose, starch, gelatin, locust bean gum, crosslinked poly(meth)acrlyates, for example polyacrlyic acid cross-linked with bis-(meth)acrylamide, furthermore silicic acid, clay such as but not limited to montmorrilionite, zeolite, dextrin, and casein.

Hydrotropes in the context with the present invention are compounds that facilitate the dissolution of compounds that exhibit limited solubility in water. Examples of hydrotropes are organic solvents such as ethanol, isopropanol, ethylene glycol, 1,2-propylene glycol, and further organic solvents that are water-miscible under normal conditions without limitation. Further examples of suitable hydrotropes are the sodium salts of toluene sulfonic acid, of xylene sulfonic acid, and of cumene sulfonic acid.

Examples of further useful enzymes other than lipase are hydrolases, amylases, proteases, cellulases, hemicellulases, lipases, phospholipases, esterases, pectinases, lactases and peroxidases, and combinations of at least two of the foregoing types of the foregoing. Particularly useful enzymes other than lipase are selected from are proteases, amylases, and cellulases. In one embodiment, at least one further enzyme may be selected from serine proteases (EC 3.4.21), alpha-amylases (EC 3.2.1.1), endoglucanases (EC 3.2.1.4), triacylglycerol lipases (EC 3.1.1.3), and endo-1,4-β-mannanases (EC 3.2.1.78).

Examples of polymers useful in the inventive laundry detergent composition are polyetheramine polyols, polyacrylic acid and its respective alkali metal salts, especially its sodium salt. A suitable polymer is in particular polyacrylic acid, preferably with an average molecular weight M_{w} in the range from 2,000 to 40,000 g/mol. preferably 2,000 to 10,000 g/mol, in particular 3,000 to 8,000 g/mol, each partially or fully neutralized with alkali, especially with sodium. Also of suitability are copolymeric polycarboxylates, in particular those of acrylic acid with methacrylic acid and of acrylic acid or methacrylic acid with maleic acid and/or fumaric acid. Polyacrylic acid and its respective alkali metal salts may serve as soil anti-redeposition agents.

Further examples of polymers are polyvinylpyrrolidones (PVP). Polyvinylpyrrolidones may serve as dye transfer inhibitors.

Further examples of polymers are polyethylene terephthalates, polyoxyethylene terphthalates, and polyethylene terephthalates that are end-capped with one or two hydrophilic groups per molecule, hydrophilic groups being selected from CH₂CH₂CH₂—SO₃Na, CH₂CH(CH₂—SO₃Na)₂, and CH₂CH(CH₂SO₂Na)CH₂—SO₃Na.

Examples of buffers are monoethanolamine and N,N,N-triethanolamine.

Examples of defoamers are silicones.

In order to be suitable as liquid laundry compositions, inventive compositions may be in bulk form or as unit doses, for example in the form of sachets or pouches. Suitable materials for pouches are water-soluble polymers such as polyvinyl alcohol.

General procedure for the synthesis of inventive cationic surfactants

The inventive cationic surfactants may, for example, be manufactured as follows.

An aminoalcohol is deprotonated using sodium methanolate (30% in methanol) (1-16 mol % relative to the aminoalcohol) and the methanol is distilled off from the mixture at elevated temperature and reduced pressure. Then the temperature is increased to 140-170° C. and the epoxide is dosed into the reaction mixture within 3 hours. After that, the reaction mixture is held up to 5 hours at 140-170° C. to allow the post reaction. Optionally, the obtained product can be distilled in vacuo to obtain the tertiary amine surfactant in high purity. The aminoalcohol can be used in excess amounts, which can be distilled off during vacuum distillation.

The tertiary amine can be quarternized subsequently in aqueous solution or without additional solvent using e.g. diemthylsulfide, methyl chloride or propylene oxide in combination with an acid such as hydrogen chloride to obtain the cationic surfactant.

### EXAMPLES

In the following paragraphs, some experimental examples are presented to illustrate certain aspects of the present invention.

A cationic surfactant was synthesized as follows. (Inventive cationic surfactant “I”)

2-[2-(dimethylamino)ethoxy]ethanol (0.75 mol) and sodium ethylate (dissolved in Methanol) (0.025 mol) were placed into a 500 mL four-necked flask under nitrogen atmosphere and heated up to 60° C. under stirring. Then Methanol was removed under vacuum at 60° C. The mixture was heated up to 160° C. and dodecene epoxide was added at 160° C. over a period of 2.5 h. To complete the reaction, the mixture post-reacted for 5 h. The control of reaction was carried out by total amine- and epoxide value. After vacuum distillation the tertiary amine compound was obtained in 95% purity having an amine number of 169.3 mg/g.

¹H-NMR (400 MHz, CDCl₃): δ (ppm)=0.82 (t, 3H, —CH₃), 1.20-1.37 (d, 18H, (—CH₂)₉), 2.20 (dd, 6H, —N(CH₃)₂), 2.45 (t, 2H, CH₂—O), 3.25 (m, 2H, —N(CH₂).

In a final step, the cationic surfactant was achieved by quaternization with dimethylsulfate, methyl chloride or propylene oxide in combination with an acid such as hydrogen chloride.

The tertiary amine compound (97 g) and water (400 g) were placed into a 5-I autoclave. After nitrogen neutralization, the pressure was adjusted to 5.0 bar and the mixture was homogenized at 86° C. for 1.5 h. Then Methyl chloride (14.4 g) was added. To complete the reaction, the mixture was post-reacted for 4 h at 86° C. The cationic surfactant was achieved with an active content of 21.3%

¹H-NMR (400 MHz, CDCl₃): δ (ppm)=0.90 (t, 3H, —CH₃), 1.28-1.45 (d, 18H, (—CH₂)₉), 3.25 (dd, 8H, —N(CH₃)₃), 3.25 (t, 2H, CH₂—O), 3.25-4.00 (m, 12H).

Comparative cationic surfactant (“C”) was synthesized as follows.

155 g 1-dimethylamino-2-propanol (1.5 mol) and 2.2 g potassium tert-butoxide (0.20 mol) were charged into a stainless-steel reactor and degassed with nitrogen. The reactor is set under 2 bar nitrogen pressure and heated to 130° C. 958 g propylene oxide (16.5 mol) are dosed into the system within 12 hours. The reaction mixture is allowed to post react for 12 hours at 130° C. Volatile compounds are removed in vacuo and 1120 g of a yellow liquid was obtained as product.

¹H NMR (500 MHz, Chloroform-d): δ(ppm)=4.02-3.10 (m, J=6.0, 2.8 Hz, 33H, —CH, —CH₂), 2.25 (s, 6H, —CH₃), 1.26-0.99 (m, 36H, —CH₃).

200 g of the obtained product (0.27 mol) were charged into a flask, flushed with nitrogen and heated to 75° C. Then, 34 g of dimethyl sulfate (DMS) (0.27 mol) were dosed into the system, keeping the internal temperature between 70 and 75° C. After the addition, the reaction mixture was allowed to post-react at 75° C. for two hours. After confirmation of absence of DMS, the reaction mixture was neutralized using 7.15 g of sodium hydroxide solution (50%).

¹H NMR (500 MHz, Chloroform-d) δ (ppm)=3.97-2.98 (m, 50H, —CH, —CH₂, —N+—(CH₃)₃), 1.48-0.74 (m, 36H, —CH₃).

Then, laundry detergent compositions containing the cationic surfactant were prepared.

Formulations (i.e. laundry detergent compositions) containing the above inventive cationic surfactant (L2), a reference formulation (L1) and a further reference formulation (L3) were manufactured as follows:

L1 was prepared by the stepwise addition of 40 wt % high purity water to 5.5 wt % Maranil, followed by the addition of 6 wt % monopropylene glycol (MPG) and 3 wt % ethanol. 5.4 wt % Lutensol A07 was added and the mixture was stirred ˜30 minutes at 50-60° C. 2.5 wt % Edenor K12-18 was added and the mixture was stirred until everything was dissolved. After the addition of 3 wt % sodium citrate (tribasic) and 5.4 wt % Texapon N70, the mixture was stirred 15 minutes at 50° C. to reach a homogeneous formulation. The pH value was adjusted with sodium hydroxide to 8.2 and the formulation was allowed to cool down to room temperature at which the pH value was re-adjusted, if necessary. The final concentration was adjusted by filling up the formulation with high purity water, leaving a 10 wt % gap for the addition of the enzyme solution.

L2 and L3 were prepared by the stepwise addition of 40 wt % high purity water to Maranil (5.5% wt % active ingredient), followed by the addition of 6 wt % monopropylene glycol (MPG) and 2 wt % ethanol. 5.4 wt % Lutensol A07 was added and the mixture was stirred at 50-60° C. for approximately 30 min. Edenor K12-18 (2.5 wt %) was added and the mixture was stirred until everything was dissolved. After the addition of 3 wt % sodium citrate (tribasic) and 1.35 wt % of the corresponding cationic surfactant, the mixture was stirred 15 minutes at 50° C. to reach a homogeneous formulation. The pH value was adjusted with sodium hydroxide (10 wt % aq) to 8.2 and the formulation was allowed to cool down to room temperature. The pH value was checked again once the formulation temperature reached room temperature and was re-adjusted, if necessary. The final concentration was adjusted by filling up the formulation with high purity water, leaving a 10 wt % gap for the addition of the enzyme solution.

L2 was first characterized with respect to their physicochemical properties at 23° C. in direct comparison to a remake of benchmark formulation L1. For this purpose, the formulation was diluted to a total surfactant content of 50 ppm. Static surface tension (SST) measurements based on the pendant drop technique (drop shape analysis on a Kruss DSA100 instrument, using droplets of formulation with a volume of approx. 7 μL) show that L2 reaches values that are similar, or even slightly lower (which is expected to be beneficial for cleaning applications), than the benchmark system, both after 1 and 60 s of equilibration in air:

TABLE 1

Surface Tension [mNm−1]

| | 1 s | 60 s |
|---|---|---|
| L1 | 46.21 | 30.84 |
| L2 | 45.90 | 29.84 |

Interfacial tensions (IFT) measured by the pendant drop technique (drop shape analysis on a Kruss DSA100 instrument, using droplets of formulation with a volume of approx. 7 μL) against triolein as oil phase (outer reservoir of about 3 mL in a conventional cuvette) confirm this observation and show a clear benefit of L2 relative to the benchmark formulation L1 (lower IFT values imply that the studied oil can more readily be solubilized and/or emulsified by the respective formulation; note that triolein is a typical oily component of common fatty stains):

TABLE 2

Interfacial Tension vs. triolein [mNm−1]

| | 1 s | 60 s |
|---|---|---|
| L1 | 12.28 | 6.29 |
| L2 | 5.32 | 3.08 |

Finally, the ability of L2 to spread on relevant stains was assessed by determining the contact angle (wetting behavior) of the dilute solutions on thin layers of fatty stains applied on a glass substrate by melting, doctor-blading of a ca. 40 wt % solution of the respective stain in toluene and subsequent cooling. By analyzing the shape of a sessile drop of formulation (volume: ca. 2 μL) on the stain layer after different equilibration times (1 and 60 s) using a Kruss DSA100 instrument, the corresponding contact angle was measured (based on the tangent method). The following table shows the results obtained when using commercial lard as a model stain; again, lower values are more beneficial as they indicate a better wettability of the stain surface, which is considered to be crucial for final removal:

TABLE 3

| | L1 | | L2 | |
|---|---|---|---|---|
| | Contact | Contact | Contact | Contact |
| Stain | Angle/1 s | Angle/60 s | Angle/1 s | Angle/60 s |
| Biskin | 95.4 | 80.4 | 94.7 | 83.2 |
| Lard | 77.3 | 66.4 | 64.2 | 53.4 |
| Beef tallow | 80.9 | 62.1 | 92.2 | 67.6 |
| Sebum | 70.3 | 60.9 | 69.4 | 62.9 |
| Tripalmitin | 84.9 | 72.2 | 90.3 | 82.6 |
| Tripalmitin/ | 98.4 | 79.7 | 99.9 | 77.3 |
| Triolein | | | | |

As in the case of the surface and interfacial tension, L2 (containing Maranil® as anionic surfactant, Lutensol® A07 as nonionic surfactant, and the inventive cationic surfactant) shows a superior effect in terms of wetting of the stain surface.

Enzyme Activity/Storage Stability:

The samples were stored in a drying cabinet at 37° C. During the testing period, aliquots were taken at defined time points and frozen at −20° C. until the determination of the enzyme activity. For the enzyme activity measurements, the samples were allowed to reach room temperature. The enzyme activity was determined at 30° C. with an in-house developed absorption-based assay using the Gallery™ machine. The Gallery™ is a semi-automated photometric analyzer with an error ≤2.5%. For the analysis, the residual enzyme activity for each time point compared to the enzyme activity at day 0 is calculated.

TABLE 4

Relative Enzyme Activity/%

| Storage Time/d | Formulation L2 | Formulation L1 |
|---|---|---|
| 0 | 100.0 ± 0.4 | 100.0 ± 1.6 |
| 2 | 91.7 ± 1.6 | 85.8 ± 2.2 |
| 7 | 51.1 ± 1.6 | 39.5 ± 0.5 |
| 28 | 16.4 ± 1.2 | 12.6 ± 2.0 |

After 28 d of storage at elevated temperature (37° C.), a relative residual enzyme activity of ˜16% was found for L2 (inventive surfactant formulation) compared to only ˜13% relative residual enzyme activity for L1 (benchmark). This means that the laundry lipase Lipex is 3% more stable in the here described inventive formulation L2 compared to the benchmark formulation L1.

Tests on detergency performance, i.e. washing or cleaning performance

General:

As lipase, commercially available Lipex® from Novozymes was used.

The primary washing performance of the inventive cationic surfactant was tested in the washing machine preparing wash solutions using water of 14° dH (2.5 mmol/L; Ca:Mg:HCO₃ 4:1:8) containing 4.0 g/L of the liquid test detergent L.1 and L.2 (see composition in Table 5) and/or in combination with 0.02% by weight active Lipex® (relative to the total weight of the composition).

Test formulation L.1 as reference does not contain the inventive cationic surfactant. In formulation L.2 lauryl ether sulphate (5%) from L.1 has been substituted by a certain amount of the inventive cationic surfactant. In formulation L.3, comparative surfactant “C” was used instead of the inventive surfactant “I”.

TABLE 5
Liquid Test Detergent Formulations Ingredients

| | Liquid Detergent Formulations | | |
|---|---|---|---|
| | L.1 | L.2 | L.3 |
| Alkylbenzene sulfonic acid (C₁₀-C₁₃), | 5.5% | 5.5% | 5.5% |
| Na salt | | | |
| C₁₃/C₁₅-Oxoalkohol reacted with | 5.4% | 5.4% | 5.4% |
| 7 moles of EO | | | |
| 1,2 propyleneglycol | 6% | 6% | 6% |
| ethanol | 2% | 2% | 2% |
| potassium coconut soap | 2.4% | 2.4% | 2.4% |
| NaOH | 2.2% | 2.2% | 2.2% |
| sodium citrate | 3% | 3% | 3% |
| lauryl ether sulphate | 5.4% | 0% | 0% |
| cationic surfactant “I” (inventive) | 0% | 1.35% | 0% |
| Cationic surfactant “C” (comparative) | 0% | 0% | 1.35% |

The test was performed in a washing machine (Miele SOFTTRONIC W 1935 WTL, 30° C., short program, 1200 rpm, 3.5 kg ballast load), where two multi-stain monitors (MS1 and MS2) were washed together with four SBL-2004 sheets (wfk Testgewebe GmbH, DE; corresponding to 32 grams of ballast soil) as additional soil ballast. The multi-stain monitors MS1 and MS2 (Table 6) contain respectively 14 and 3 standardized soiled fabrics, of respectively 5.0×5.0 cm and 4.5×4.5 cm size and stitched on two sides to a polyester carrier.

TABLE 6
Multi-stain monitors used for the evaluation
of the cleaning performance

| | |
|---|---|
| MS1: | |
| EMPA 142/1: | polyester/cotton (65/35) soiled with lipstick |
| wfk 10D: | pigment/sebum on cotton |
| CFT C-S-67: | mustard on cotton |
| CFT PC-S-04: | saturated with colored olive oil on Polyester/Cotton |
| | (65/35) |
| CFT C-S-170: | chocolate mousse, aged on cotton |
| CFT-C-S-68: | chocolate ice cream on cotton |
| CFT-C-09: | pigment/oil not according to Australian standard on |
| | cotton |
| CFT C-S-61: | beef fat, coloured on cotton |
| CFT C-S-79: | napolina tomato on cotton |
| CFT C-S-17: | fluid make-up on cotton |
| CFT C-S-75: | blood/beef fat on cotton |
| CFT C-S-06: | salad dressing with natural black on cotton |
| CFT C-S-44: | chocolate drink, pure on cotton |
| CFT C-S-38: | egg yolk, with carbon black, aged by heating, on cotton |
| MS2: | |
| CFT C-S-10: | butterfat with colorant on cotton |
| CFT C-S-62: | lard, colored on cotton |
| CFT C-S-61: | beef fat, colored on cotton |

The total level of cleaning was evaluated using color measurements. With the aid of the CIELab color space classification, the brightness L*, the value a* on the red—green color axis and the b* value on the yellow—blue color axis, were measured before and after washing and averaged for the 16 and 4 stains of the monitors respectively using the MACH5 Multi Area Color-measurement from Colour Consult. The change of the color value (Delta E, ΔE), defined and calculated automatically by the evaluation color tools on the following formula

ΔE*_{ab}=\sqrt{ΔL^{*2}+Δa^{*2}+Δb^{*2}}

which is a measure of the achieved cleaning effect.

Higher Delta E values show better cleaning. For each stain, a difference of 1 unit can be detected visually by a skilled person. A non-expert can visually detect 2 units easily. The ΔE values of the formulations L.1, L.2 and L.3 for the sum of the 14 and 4 stains of correspondingly MS1 and MS2 and for selected single stains are shown in Table 7. Calculation of ΔE values is software-based, and it occurs automatically. Washing machine results show a better cleaning performance for the formulation L.2. containing the inventive cationic surfactant “I” and no lauryl ether sulphate component. Results also demonstrate that the total additional cleaning performance benefit of the lipase is higher for L.2, demonstrating a synergism benefit when combining the cationic surfactant and the lipase in a formulation with no lauryl ether sulphate. The formulation L.3 as comparative example containing the cationic surfactant “C” shows no cleaning performance benefit on the tested stains.

TABLE 7
Results of washing machine test fabric monitors

| | | ΔE | ΔE | ΔE | ΔE |
|---|---|---|---|---|---|
| | | (CFT | (CFT | (CFT | (CFT |
| | Total ΔE | C-S-61) | C-S-75) | C-09) | C-S-68) |
| Formulation | MS1 + MS2 | MS2 | MS1 | MS1 | MS1 |
| L.1 | 276 | 27.9 | 27.6 | 7.9 | 15.3 |
| L.2 | 291 | 29.8 | 29.6 | 8.8 | 16.3 |
| L.3 | 273 | 27.2 | 27.1 | 7.8 | 15.0 |
| L.1 + | 290 | 31.4 | 28.0 | 9.0 | 17.0 |
| 0.02% by | | | | | |
| weight | | | | | |
| active Lipex ® | | | | | |
| L.2 + | 320 | 37.8 | 33.0 | 10.8 | 19.0 |
| 0.02% by | | | | | |
| weight | | | | | |
| active Lipex ® | | | | | |

1. A laundry detergent composition, comprising at least one cationic surfactant of the formula X⁻ 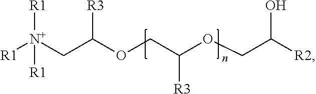
wherein X represents an anionic counterion, n is from 1 to 5, R1 are independently from each other selected from the group consisting of —CH3, —C2H5, and —C3H7, R2 is selected from the group consisting of linear, branched or cyclic alkyl moieties with 4 to 18 C atoms and R3 independently from each other represent hydrogen, at least one enzyme, and optionally at least one compound selected from the group consisting of anionic surfactants and nonionic surfactants.

2. The laundry detergent composition according to claim 1, wherein X is selected from the group consisting of —OSO3Me⁻, —Cl⁻, —I⁻ and —Br⁻.

3. The laundry detergent composition according to claim 1, wherein n is 1.

4. The laundry detergent composition according to claim 1, wherein R1 represents —CH3.

5. The laundry detergent composition according to claim 1, wherein R2 is selected from the group consisting of alkyl moieties with 4, 6, 8, 10, 12 C atoms.

6. The laundry detergent composition according to claim 1, wherein X is selected from the group consisting of —OSO3Me⁻ and —Cl⁻, n=1, R1 represents —CH3, R2 is a linear alkyl moiety with 10 C atoms and R3 is hydrogen.

7. The laundry detergent composition according to claim 1, wherein the laundry detergent composition is a liquid laundry detergent composition.

8. The laundry detergent composition according to claim 1, comprising additionally at least one anionic surfactant.

9. The laundry detergent composition according to claim 8, wherein the anionic surfactant is a sulfate or sulfonate or combinations thereof.

10. The laundry detergent composition according to claim 8, wherein the anionic surfactant is selected from the group consisting of alkylether sulfates and alkylbenzene sulfonates or combinations thereof.

11. The laundry detergent composition according to claim 8, wherein the ratio between the cationic surfactant and the anionic surfactant is in the range of 1:1 to 1:10.

12. The laundry detergent composition according to claim 1, comprising additionally at least one nonionic surfactant.

13. The laundry detergent composition according to claim 12, wherein the ratio between the cationic surfactant and the nonionic surfactant is in the range of 1:0-1:10.

14. The laundry detergent composition according to claim 1, wherein the enzyme is selected from the group consisting of proteases, amylases, mannanases, lipases and cellulases.

15. The laundry detergent composition according to claim 14, wherein the amount of lipase in the laundry detergent composition lipase is 0.0002%-0.02% by weight active, relative to the total weight of the composition.

16. The laundry detergent composition according to claim 1, comprising at least one anionic surfactant, at least one nonionic surfactant and at least one enzyme.

17. A method of using a cationic surfactant of the formula X⁻ 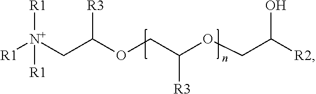
wherein X represents an anionic counterion, n is from 1 to 5, R1 are independently from each other selected from the group consisting of —CH3, —C2H5, and —C3H7, R2 is selected from the group consisting of linear, branched or cyclic alkyl moieties with 4 to 18 C atoms and R3 independently from each other represent hydrogen, the method comprising using the cationic surfactant for increasing enzyme stability in a laundry detergent composition comprising at least one enzyme.

18. A process for removing fatty stains on a textile fabric, the processing comprising using the laundry detergent composition according to claim 1.

19. The laundry detergent composition according to claim 1, wherein X is —OSO3Me⁻ or —Cl⁻.

20. The laundry detergent composition according to claim 1, wherein R2 is selected from the group consisting of alkyl moieties with 10 C atoms.
